(19) United States
(12) Patent Application Publication
(10) Pub. No.: US 2021/0090092 A1
(43) Pub. Date: Mar. 25, 2021

(54) ITEM TRACKING AND THEFT DETERRENCE

(71) Applicant: Nicholas Kammes, Elkhorn, WI (US)

(72) Inventor: Nicholas Kammes, Elkhorn, WI (US)

(21) Appl. No.: 17/025,641

(22) Filed: Sep. 18, 2020

Related U.S. Application Data
(60) Provisional application No. 62/902,454, filed on Sep. 19, 2019.

(51) Int. Cl. G06Q 30/00; H04W 4/029; G06Q 10/08; G06Q 50/26

(52) U.S. Cl. CPC G06Q 30/0185; H04W 4/029; G06Q 50/265; G06Q 10/0838; G06Q 10/0833

(57) ABSTRACT

Item tracking and theft deterrence is provided to customers utilizing a shipper to receive shipments. A customer or a rule can initiate tracking and theft deterrence to be added to shipment of an item they have ordered or want to ship. A device for tracking and theft deterrence is secured with the item to be shipped. The device relays the location of the item so that the location can be tracked in real time by the customer. The device also collects or relays fidelity data to capture how the item is being treated by the shipper during shipment. Upon delivery, theft monitoring and deterrence by the device is triggered. If the device detects a theft, the device can implement theft deterrent measures or evidence collection to identify the thief. If the device does not detect a theft, the customer can deactivate theft monitoring to pick up the package.

### CROSS-REFERENCE TO RELATED APPLICATIONS

This application claims the benefit of U.S. Provisional Patent Application Ser. No. 62/902,454 filed on Sep. 19, 2019 and entitled “PACKAGE TRACKING SYSTEM AND METHOD”, the entirety of which is expressly incorporated herein by reference.

### BACKGROUND

Tracking shipments has become increasingly important. Electronic commerce shipments and deliveries are a daily occurrence. Damaged, mistreated, or stolen shipments are more prevalent as a result of increased shipment volume. Typically, customers can follow shipment progress by the shipment getting scanned at every waypoint during transit. For example, a shipment gets scanned at the origin, at a distribution center, and at the destination. The customer only receives updates of where the shipment is scanned and does not have access to real time information about the shipment. Further, the customer can only track location data at waypoints. The customer does not receive data detailing how the shipment is treated while in transit to the customer.

Delivery of a shipment is usually completed by leaving the shipment outside and unprotected from theft. A delivery drive typically will leave the shipment at a doorstep or porch where the package can be picked up by the customer, a thief, passersby, and/or the like. The shipment is unprotected and thieves are not deterred from taking the package.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The subject disclosure generally pertains to item tracking and theft deterrence. Item tracking and theft deterrence is provided to customers utilizing a shipper to receive shipments. A customer or a rule can initiate tracking and theft deterrence to be added to shipment of an item they have ordered or want to ship. A device for tracking and theft deterrence is secured with the item to be shipped. The device relays the location of the item so that the location can be tracked in real time by the customer. The device also collects or relays fidelity data to capture how the item is being treated by the shipper during shipment. Upon delivery, theft monitoring and deterrence by the device is triggered. If the device detects a theft, the device can implement theft deterrent measures or evidence collection to identify the thief. If the device does not detect a theft, the customer can deactivate theft monitoring to pick up the package.

In aspects, the subject innovation provides substantial benefits in terms of item tracking and theft deterrence. One advantage resides in more transparent knowledge of the location and treatment of a shipment. Another advantage resides in protecting a package from theft upon arrival at the destination and before pickup by a customer.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings.

FIG. 1 illustrates a system diagram for item tracking and theft deterrence.

FIG. 2 illustrates an example component diagram of a tracer system and a device in accordance with aspects of the innovation.

FIG. 3 illustrates an example component diagram of a deterrent component in accordance with an aspect of the innovation.

FIG. 4 illustrates an example component diagram of a collection component in accordance with aspects of the innovation.

FIG. 5 illustrates an example method for item tracking and theft deterrence in accordance with aspects of the innovation.

FIG. 6 illustrates a computing environment where one or more of the provisions set forth herein can be implemented, according to some embodiments.

### DETAILED DESCRIPTION

The subject disclosure generally pertains to item tracking and theft deterrence. Item tracking and theft deterrence is provided to customers utilizing a shipper to receive shipments. A customer or a rule can initiate tracking and theft deterrence to be added to shipment of an item they have ordered or want to ship. A device for tracking and theft deterrence is secured with the item to be shipped. The device relays the location of the item so that the location can be tracked in real time by the customer. The device also collects or relays fidelity data to capture how the item is being treated by the shipper during shipment. Upon delivery, theft monitoring and deterrence by the device is triggered. If the device detects a theft, the device can implement theft deterrent measures or evidence collection to identify the thief. If the device does not detect a theft, the customer can deactivate theft monitoring to pick up the package.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to incorporate all modifications, equivalents, and alternatives falling within the spirit and scope of this specification and claims appended hereto.

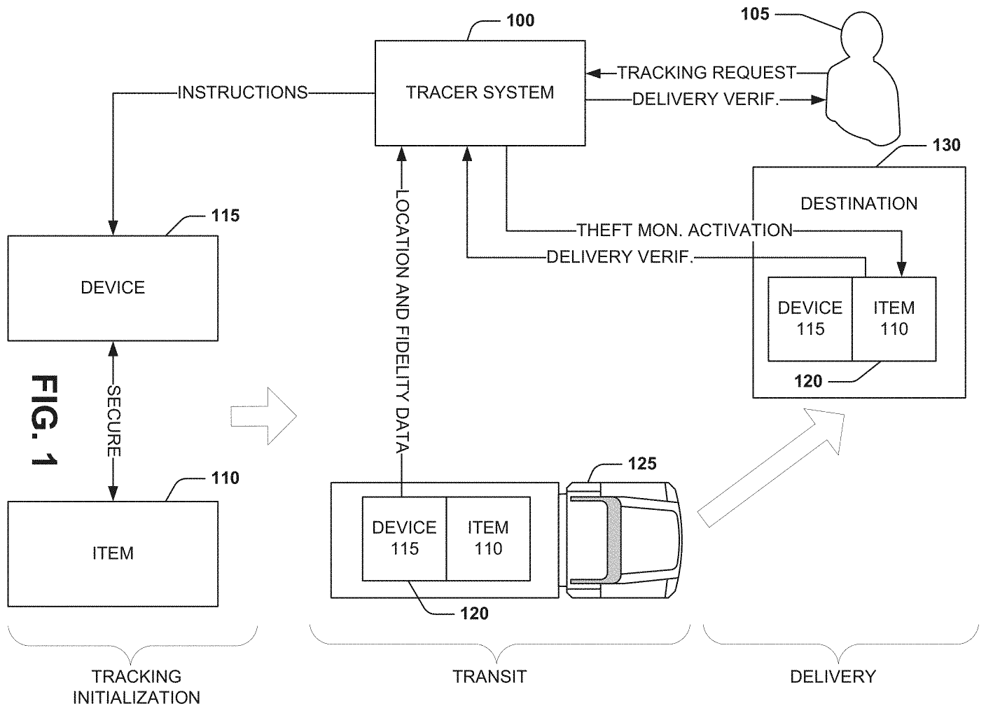

FIG. 1 illustrates an example tracer system 100 that facilitates item tracking and theft deterrence. A customer 105 can initiate a tracking request or tracking indication of an item 110 with the tracer system 100. In some embodiments, the tracking request can be explicitly made by the customer 105. For example, the customer 105 submits a request for tracking when ordering a television from an e-commerce site. In other embodiments, the tracking request is automatically triggered according a predetermined rules. For example, predetermined rules can be value or cost threshold of the item 110, nature of the item 110 (e.g. electronics, refrigerated food, and/or the like), fragility of the item 110, and/or the like.

In some embodiments, the tracer system 100 is integrated with an e-commerce site such that tracking requests are seamlessly integrated during a checkout process. In some embodiments, the integration is preformed via an application programming interface (API). For example, when the customer 105 orders a television on the checkout page of the e-commerce site, the tracking system 100 can perform an API call and response with the e-commerce site on the checkout page in the form of a pop up, a redirect, a box on the page, and/or the like to select or trigger tracking of the item.

The tracer system 100 can send initialization instructions to a device 115. In some embodiments, the tracer system 100 can send instructions to a shopper, packager, warehouse agent, and/or shipping agent responsible to completing the shipping of the item 110. The initialization instructions can include a wake up trigger to begin tracking. In some embodiments, the device 115 includes a manual button to begin tracking. In other embodiments, the wake up trigger can be remotely initiated from the tracer system 100.

In some embodiments, the device 115 is stored in a warehouse, distribution center, and/or otherwise co-located where item(s) 110 is/are stored. In other embodiments, an item 110 may be transferred to where the device 115 is stored or the device 115 is transferred to where the item 110 is stored. In some embodiments, an agent (e.g. a warehouse employee) may scan the device 115 and scan a customer order for the item 110 to generate an association between the device 115 and the item 110. The association is stored at the tracer system 100.

The device 115 is secured to or with the item 110. In some embodiments, the device 115 can be attached to the outside of the item 110, in the same container or package as the item 110, or otherwise secured with the item 110. In other embodiments, the device 115 is included in a blister pack that is affixed to the item 110 (e.g. an adhesive backing on the blister pack to attach the device to the box of the item 110). The securing of the device 115 with the item 110 can create a device-item pair 120.

The device-item pair 120 is shipped via a shipping mode 125. The shipping mode 125 can be by land (e.g. motor vehicle, train, and/or the like), air (e.g. plane, drone, and/or the like), sea (e.g. boat), and/or a combination thereof. In some embodiments, the shipping mode 125 is associated with a courier service, postal service, messenger, shipper, airline, a combination thereof, and/or the like. In other embodiments, the shipping mode 125 is associated with a shipping company having a portal for tracking the shipping process.

The device 115 provides tracking data to the tracer system 100 during shipping or transit by the shipping mode 125. The tracking data can include location data. In some embodiments, the device 115 can provide global positioning system (GPS) coordinates to the tracer system 100. The device 115 can provide location data periodically, continuously (in real time or near-real time), and/or the like. In some embodiments, the device 115 follows a reporting schedule. For example, the device 115 can provide location data every 15 or 30 minutes between 7:00 am and 7:00 pm, and every 4 hours between 7:01 pm and 6:59 am. The schedule times can be based on the time zone of the delivery address, the current location, originating location, and/or the like. In some embodiments, the scheduled reporting intervals can be variable based on a battery level and/or the like.

The tracking data can include fidelity data. The device 115 can monitor how the device-item pair 120, the device 115, and/or the item 110 are treated during transit to a destination 130. The fidelity data can include movement (e.g. speed, acceleration, deceleration, and/or the like), g-force, temperature, humidity, brightness, and/or the like. In some embodiments, the type of fidelity data provided to the tracer system 100 is determined by the nature or characteristics of the item 110. For example, a perishable food item can trigger temperature fidelity data to be collected by the device 115 and sent to the tracer system 100.

The fidelity data can be sent continuously, periodically, in response to a request (or ping), triggered according a threshold being met, triggered according to a detected change in fidelity data, and/or the like. For example, the perishable food item must be kept below zero degrees Celsius. The fidelity data can be sent to the tracer system 100 if/when the device 115 detects a temperate above zero degrees Celsius. In another example, the device 115 can send fidelity data upon detection of a g-force above one G.

In some embodiments, the customer 105 can access the tracer system 100 to access the tracking data sent by the device 115. In some embodiments, the customer 105 can use a mobile application on a customer device to access the tracer system 100. In other embodiments, the customer 105 can use a website associated with the tracer system 100, the e-commerce website, the shipper/courier website, and/or the like to access the tracer system 100. The customer 105 can trigger collecting tracking data upon accessing the tracer system 100 or navigating a user interface of the tracer system 100. In some embodiments, the customer 105 can select multiple profiles of the device 115 where each profile dictates which tracking data is recorded by the device 115. In other embodiments, the customer 105 can turn on or off different tracking data to be recorded via the application.

The device-item pair 120 can be delivered to the destination 130 by the shipper mode 125 or agent of the shipping mode 125. Upon delivery of the device-item pair 120, the tracer system 100 can activate theft monitoring by the device 115. For example, the device-item pair 120 can be delivered on a doorstep at the destination 130. The tracer system 100 and/or the device 115 can detect delivery at the destination 130 and activate theft monitoring. In some embodiments, the tracer system 100 and/or the device 115 detects delivery at the destination 130 by matching location of the device 115 and a known location data of the destination. For example, matching GPS coordinates of the device 115 to GPS coordinates of the destination 130. In some embodiments, the match can be within a threshold distance from one another. In some embodiments, the device 115 can determine delivery through detecting a lack of motion of the device 115 for a predetermined amount of time (e.g. a timeout period) at the destination 130. The timeout period may allow for a delivery person or agent to finalize delivery at the destination 130 before theft monitoring is triggered. In other embodiments, the device 115 uses a combination of location and motion timeout period to determine delivery. In some embodiments, the device 115 can determine delivery at the destination 130 by detecting and/or connecting to an internet of things (IOT) device or wireless network associated or located at the destination 130 or customer 105.

In some embodiments, delivery is determined upon the delivery person scanning a code on the device-item pair 120, the device 115, and/or the item 110. In other embodiments, delivery is determined by detecting a delivery acknowledgment on the shipping mode 125 website. Upon scanning the item, the item can be listed or status is updated as delivered to the destination via a shipping company portal, website, application, and/or the like. The tracer system 100 can determining the item is delivered by connecting to the shipping company portal to determine the item has been marked as delivered. The tracer system 100 can connect to the shipping company portal via an API call/response to retrieve the status data about the item. The tracer system 100 can determine delivery by an API call/response to retrieve the status of the item (e.g. in transit, out for delivery, delivered, and/or the like).

Upon detecting a delivery, in some embodiments, the tracer system 100 can generate and send a notification in real time to the customer 105. The customer 105 can deactivate theft monitoring by the device 115 prior to moving or confirming receipt of the device-item pair 120, the device 115, and/or the item 110. The customer 105 can access the tracer system 100 to disable the theft monitoring via a user interface, notification, scanning a code on the device-item pair 120, the device 115, and/or the item 110, replying a one-time passcode protocol, and/or the like. In some embodiments, the customer 105 can assign an agent (e.g. a household member, family member, friend, and/or the like) in the tracer system 100 to deactivate the theft monitoring to pick up the device-item pair 120, the device 115, and/or the item 110. The assignment can be sent to contact information of the agent provided by the customer 105.

The tracer system 100 and/or the device 115 can monitor the device-item pair 120, the device 115, and/or the item 110 once it has been delivered or upon detecting delivery to the destination 130. The device 115 can detect a theft by determining a change in tracking data once theft monitoring has been activated. The device 115 can determine a theft by detecting motion of the item. The device 115 can detect motion by detecting a change in location, an applied g-force, a change or departure from a wireless network signal, a disconnection from an IOT device, and/or the like. In other embodiments, the device 115 can determine a theft or supplement a theft determination using other tracking data. For example, the device 115 can detect a brightness level change, a sound level change, and/or the like that indicate the device-item pair 120 has been opened or tampered.

If the device 115 detects a theft of the device-item pair 120, the device 115, and/or the item 110, the device 115 can implement theft deterrent measures. The theft deterrent measures can include generating and sending a notification to the customer 105, sounding an alarm, vibrating the device 115, calling or communicating with a police or law enforcement authority, opening a communication line with the thief, broadcasting the location of the device 115 to the tracer system 100, and/or the like. For example, when motion is detected by the device 115, the device 115 can dial a law enforcement number and open a call between law enforcement and a potential thief. The device 115 can continuously or periodically send location information to the tracer system 100, the customer 105, to law enforcement, and/or the like.

If the device 115 detects a theft of the device-item pair 120, the device 115, and/or the item 110, the device 115 can implement evidence collection. The evidence collection can include collecting images, video, audio, ambient measurements, surrounding network information, biometrics of a potential thief, and/or the like. For example, upon detecting a theft, the device 115 can determine a second location where the device 115 has stopped moving. The device 115 scans surrounding networks (e.g. wireless networks) at the second location to find information about the thief. In some embodiments, the device 115 can also record video and audio upon detecting the device-item pair 120 has been opened. In another example, the device 115 can scan for a Bluetooth identifier to determine the thief's phone data or vehicle data (e.g. make and/or model of car).

Upon a successful pickup of the device-item pair 120, the device 115, and/or the item 110 by the customer 105 (or agent of the customer 105), the tracer system 100 may provide instructions to the customer 105 to return the device 115. In some embodiments, the device 115 includes packaging for the device 115 and mail to a warehouse, or tracer system 100 location. When a device 115 is returned, the tracer system 100 can generate and send a notification to the customer 105 to complete a device 115 cycle to make the device 115 available for another shipment. In other embodiments, the customer may be instructed to dispose of the device 115.

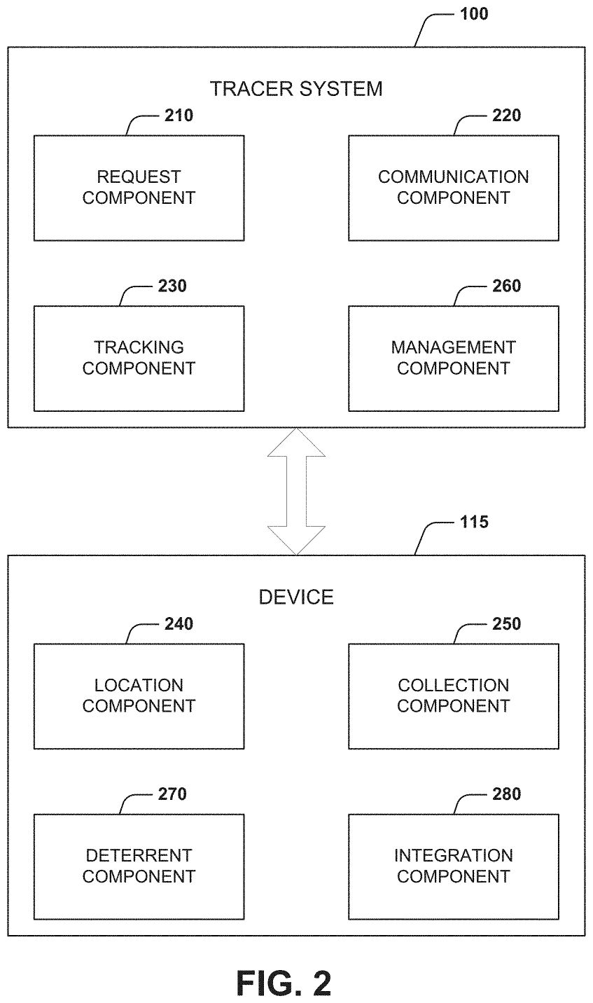

FIG. 2 illustrates an example component diagram of a tracer system 100 in connection with a device 115. The tracer system 100 can include a request component 210. The request component 210 can receive a tracking request of an item 110 with the tracer system 100. In some embodiments, the tracking request can be explicitly made by the customer 105. For example, the customer 105 submits a request for tracking when ordering a television from an e-commerce site. In other embodiments, the tracking request is automatically triggered according a predetermined rules. For example, predetermined rules can be a value or cost threshold of the item 110, nature of the item 110 (e.g. electronics, refrigerated food, and/or the like), and/or the like.

In some embodiments, the request component 210 integrates with an e-commerce site such that tracking requests are seamlessly integrated during a checkout process. In some embodiments, the integration is preformed via an application programming interface (API). For example, when the customer 105 orders a television on the checkout page of the e-commerce site, the request component 210 can perform an API call and response on the checkout page in the form of a pop up, redirect, box on the page, and/or the like to select or trigger tracking of the item.

The tracer system 100 can include a communication component 220. In some embodiments, the communication component 220 can send initialization instructions to a device 115. In some embodiments, the tracer system 100 can send instructions to a packager or shipping agent responsible to completing the shipping of the item 110. The initialization instructions can include a wake up trigger to begin tracking. In some embodiments, the device 115 includes a manual button to begin tracking. In other embodiments, the wake up trigger can be remotely initiated from the communication component 220.

The device 115 provides tracking data to a tracking component 230 of the tracer system 100 during shipping or transit to the destination. The device 115 includes a location component 240. The location component 240 provides location data of the device 115 to the tracking component 230. In some embodiments, the location component 240 can provide global positioning system (GPS) coordinates to the tracking component 230. The location component 240 can provide location data periodically, continuously (in real time or near-real time), and/or the like. In some embodiments, the location component 240 follows a reporting schedule. For example, the location component 240 can provide location data every 15 or 30 minutes between 7:00 am and 7:00 pm, and every 4 hours between 7:01 pm and 6:59 am. The schedule times can be based on the time zone of the delivery address, the current location, originating location, and/or the like. In some embodiments, the scheduled reporting intervals can be variable based on a battery level and/or the like.

The device 115 can provide fidelity data to the tracking component 230. The device 115 includes a collection component 250. The collection component 250 can monitor how the device-item pair 120, the device 115, and/or the item 110 are treated during transit to a destination 130. The fidelity data can include movement (e.g. speed, acceleration, deceleration, and/or the like), g-force, temperature, humidity, brightness, and/or the like. In some embodiments, the type of fidelity data provided to the tracking component 230 is determined by the nature of the item 110. For example, a perishable food item can trigger temperature fidelity data to be collected by the device 115 and sent to the tracking component 230 by the collection component 250.

The fidelity data can be sent continuously, periodically, in response to a request (or ping), triggered according a threshold being met, triggered according to a detected change in fidelity data, and/or the like. For example, the perishable food item must be kept below zero degrees Celsius. The fidelity data can be sent to the tracking component 230 if/when the collection component 250 detects a temperature above zero degrees Celsius. In another example, the collection component 250 can send fidelity data upon detection of a g-force above one G.

The tracer system 100 includes a management component 260. Upon delivery of the device-item pair 120, the management component 260 can activate theft monitoring by the device 115. For example, the device-item pair 120 can be delivered on a doorstep at the destination 130. The management component 260 and/or the device 115 can detect delivery at the destination 130 and activate theft monitoring. In some embodiments, the management component 260 and/or the location component 240 detects delivery at the destination 130 by matching location of the device 115 and a known location data of the destination. For example, matching GPS coordinates from the location component 240 to GPS coordinates of the destination 130. In some embodiments, the match can be within a threshold distance from one another.

The device 115 includes a deterrent component 270. In some embodiments, the deterrent component 270 can determine delivery through detecting a lack of motion of the device 115 for a predetermined amount of time (e.g. a timeout period). The timeout period may allow for a delivery driver to finalize delivery at the destination 130 before triggering theft monitoring by the management component 260. In other embodiments, the management component 260 uses a combination of location from the location component 240 and motion timeout period from the deterrent component 270 to determine delivery.

In some embodiments, the device 115 includes an integration component 280. The integration component 280 can determine delivery at the destination 130 by detecting and/or connecting to an internet of things (IOT) device and/or wireless network associated or located at the destination 130 or customer 105. In some embodiments, the integration component 280 can integrate with an IOT security camera associated with the destination 130. The integration component 280 can instruct the IOT security camera to focus (or hold still on the device-item pair 120 if the IOT security camera pans over an area) on the device-item pair 120, the device 115, and/or the item 110 for better theft deterrence and identification of potential thieves. The integration component 280 can instruct the IOT security camera to send recorded video and audio of a theft to the tracer system 100 and/or the customer 105 upon detecting a theft.

Upon detecting a delivery, in some embodiments, the communication component 220 can generate and send a notification in real time to the customer 105. In some embodiments, the customer 105 can deactivate theft monitoring via the management component 260 and/or the communication component 220 prior to moving or confirming receipt of the device-item pair 120, the device 115, and/or the item 110. The customer 105 can access the management component 260 and/or the communication component 220 to disable the theft monitoring via a user interface, notification, scanning a code on the device-item pair 120, the device 115, and/or the item 110, replying a one-time passcode protocol, and/or the like.

The tracer system 100 and/or the device 115 can monitor the device-item pair 120, the device 115, and/or the item 110 once it has been delivered or upon detecting delivery to the destination 130. The deterrent component 270 can detect a theft by determining a change in tracking data once theft monitoring has been activated. The deterrent component 270 can determine a theft by detecting motion of the item. The deterrent component 270 can detect motion by detecting a change in location, an applied g-force, and/or the like. In other embodiments, the deterrent component 270 can determine a theft or supplement a theft determination using other tracking data. For example, the deterrent component 270 can detect a brightness level change, a sound level change, and/or the like that indicate the device-item pair 120 has been opened, tampered, and/or the like.

In some embodiments, the collection component 250 can determine theft by detecting a change or departure from a wireless network signal, a presence of new wireless network signals, and/or the like. For example, detecting a presence of one or many new wireless networks can be indicative of a change in venue (e.g. theft) from the destination 130. Conversely, detecting an absence (sudden, or within a threshold amount of time) of observed (over time) wireless networks are indicative of a change in venue (e.g. theft) from the destination 130.

If the device 115 detects a theft of the device-item pair 120, the device 115, and/or the item 110, the deterrent component 270 can implement theft deterrent measures. The theft deterrent measures can include generating and sending a notification to the customer 105, sounding an alarm, vibrating the device 115, calling or communicating with a police or law enforcement authority, broadcasting the location of the device 115 to the tracer system 100, and/or the like. For example, when motion is detected by the deterrent component 270, the deterrent component 270 can dial a law enforcement number and open a call between law enforcement and a potential thief. The deterrent component 270 can continuously or periodically send location information to the tracer system 100, the customer 105, to law enforcement, and/or the like.

If the device 115 detects a theft of the device-item pair 120, the device 115, and/or the item 110, the collection component 250 can implement evidence collection. The evidence collection can include collecting images, video, audio, ambient measurements, surrounding network information, biometrics of a potential thief, and/or the like. For example, upon detecting a theft, the deterrent component 270 can determine a second location where the device 115 has stopped moving. The collection component 250 scans surrounding networks (e.g. wireless networks) at the second location to find information about the thief, such as address associated with a registered router, wireless network, internet provider, and/or the like. In some embodiments, the collection component 250 can also record video and audio upon detecting the device-item pair 120 has been opened.

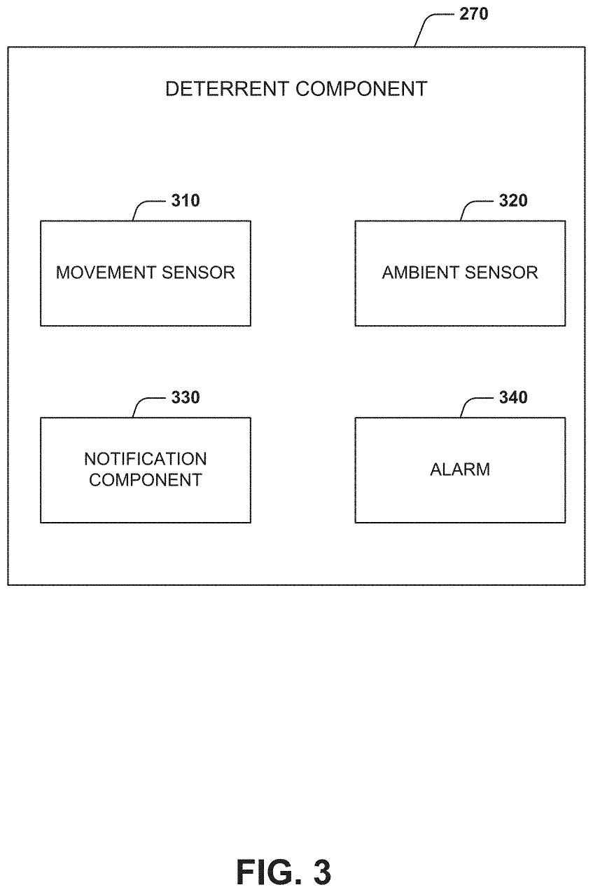

FIG. 3 illustrates an example component diagram of a deterrent component 270. The deterrent component 270 includes a movement component 310. In some embodiments, the movement component 310 can determine delivery through detecting a lack of motion of the device 115 for a predetermined amount of time (e.g. a timeout period). The timeout period may allow for a delivery driver to finalize delivery at the destination 130 before triggering theft monitoring by the management component 260. In other embodiments, the management component 260 uses a combination of location from the location component 240 and motion timeout period from the movement component 310 to determine delivery.

The movement component 310 can detect a theft by detecting motion of the item. The movement component 310 detects motion by detecting a change in location, an applied g-force, and/or the like. In some embodiments, the movement component 310 includes an accelerometer for detecting motion.

In some embodiments, the deterrent component 270 includes an ambient sensor 320. The ambient sensor 320 can determine a theft or supplement a theft determination using other tracking data. For example, the ambient sensor 320 can detect a brightness level change, a sound level change, and/or the like that indicate the device-item pair 120 has been opened, tampered, moved, destroyed, and/or the like.

The deterrent component 270 includes a notification component 330. If the device 115 detects a theft of the device-item pair 120, the device 115, and/or the item 110, the notification component 330 can implement theft deterrent measures. The notification component 330 can generate and send a notification to the tracer system 100, to the customer 105, or to an IOT device associated with the customer 105. In some embodiments, the notification component 330 can call or open a communication channel with a police or law enforcement authority, broadcast the location of the device 115 to the tracer system 100, customer 105, or law enforcement, and/or the like. For example, when motion is detected by the movement component 310, the notification component 330 can dial a law enforcement number and connect a communication channel or call between law enforcement and a potential thief.

The deterrent component 270 includes an alarm 340. Upon detecting a theft, the alarm 340 can generate an alarm such as a sound or a vibration to deter the potential theft. In some embodiments, the alarm 340 includes a wind down feature. The wind down feature can make a sound similar to when an alarm battery fails, loses charge, or wears down after a predetermine period of time. The wind down can lead the potential thief into thinking they were successful, while other theft deterrent features or evidence collection features are implemented.

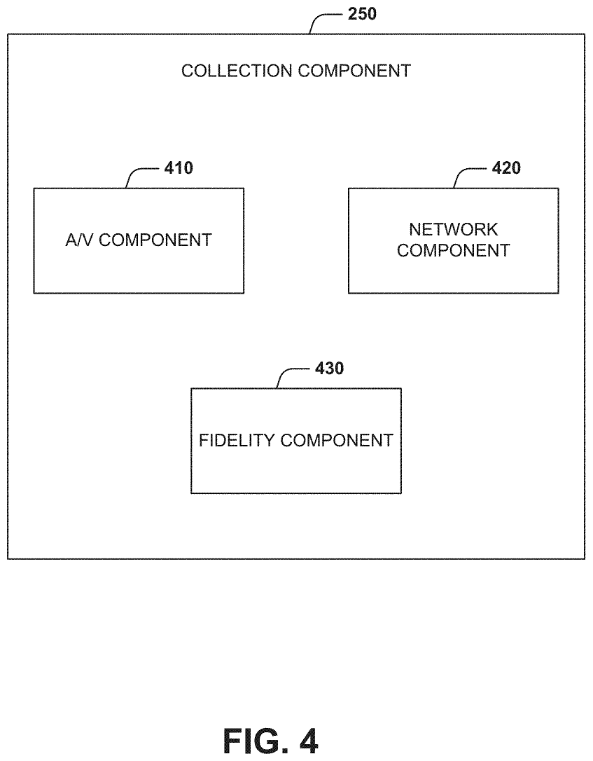

FIG. 4 illustrates an example component diagram of a collection component 250. If the device 115 detects a theft of the device-item pair 120, the device 115, and/or the item 110, the collection component 250 can implement evidence collection. The collection component 250 includes an audio-visual (A/V) component 410. In some embodiments, the A/V component 410 begins recording audio and/or video upon a theft being detected. In other embodiments, the A/V component 410 can record video and audio upon detecting the device-item pair 120 has been opened. In some embodiments, the audio and/or video can be sent to the tracer system 100 for storage or later use in identifying the thief. In other embodiments, the audio and/or video can be used to biometrically identify the thief.

In some embodiments, the collection component 250 includes a network component 420. The network component 420 can determine theft by detecting a change or departure from a wireless network signal, a presence of new wireless network signals, and/or the like. For example, detecting a presence of many new wireless networks can be indicative of a change in venue (e.g. theft) from the destination 130. Conversely, detecting an absence (sudden, or within a threshold amount of time) of observed (over time) wireless networks are indicative of a change in venue (e.g. theft) from the destination 130.

For example, upon detecting a theft, the deterrent component 270 can determine a second location where the device 115 has stopped moving. The network component 420 scans surrounding networks (e.g. wireless networks) at the second location to find information about the thief, such as address associated with a registered router, wireless network, internet provider, and/or the like.

In some embodiments, the collection component 250 includes a fidelity component 430. The fidelity component 430 can monitor how the device-item pair 120, the device 115, and/or the item 110 are treated during transit to a destination 130. The fidelity data can include movement (e.g. speed, acceleration, deceleration, and/or the like), g-force, temperature, humidity, brightness, and/or the like. In some embodiments, the type of fidelity data provided to the tracking component 230 is determined by the nature of the item 110. For example, a perishable food item can trigger temperature fidelity data to be collected by the fidelity component 430 and sent to the tracking component 230.

The fidelity component 430 can send the fidelity data continuously, periodically, in response to a request (or ping), triggered according a threshold being met, triggered according to a detected change in fidelity data, and/or the like. For example, the perishable food item must be kept below zero degrees Celsius. The fidelity data can be sent to the tracking component 230 if/when the fidelity component 430 detects a temperature above zero degrees Celsius. In another example, the collection component 250 can send fidelity data upon detection of a g-force above one G.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull control model. The components may also interact with one or more other components not specifically described herein for sake of brevity, but appreciated by those of skill in the art.

Furthermore, various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Among other things, such components can automate certain mechanisms or processes performed thereby to make portions of the systems and methods more adaptive as well as efficient and intelligent. By way of example, and not limitation, such mechanisms can be utilized by the tracer system 100 and/or device 115.

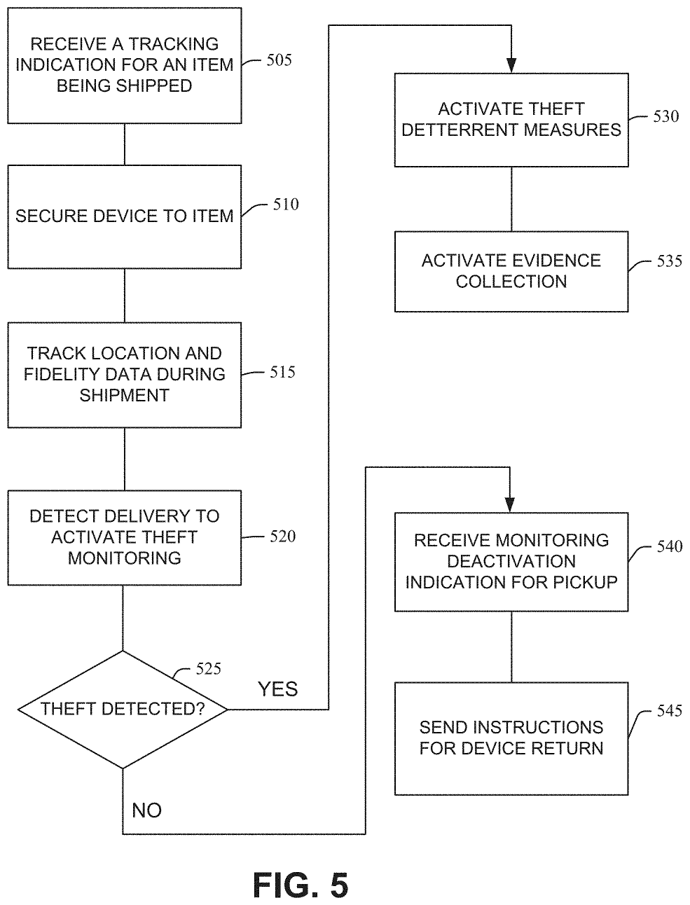

In view of the example systems described above, methods that may be implemented in accordance with the disclosed subject matter will be better appreciated with reference to flow chart diagram of FIG. 5. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 5 illustrates a method 500 for item tracking and theft deterrence. At 505, an indication is received to track an item to a destination. The indication can be received by the tracer system 100. The indication can be a formal request for tracking from a customer. In some embodiments, the indication is triggered according to predetermined rules. For example, a predetermined rule to trigger the indication or tracking is based on the price of the item, nature of the item, and/or the like.

At 510, a device 115 is secured with the item 110. Upon receiving the indication, instructions can be communicated to secure the device to the item. The device can be associated with the item and the association stored by the tracer system 100. The device is trackable to determine a location of the item and fidelity data of the item. At 515, the location of the device and the item are tracked to the destination. The device 115 can send location data such as GPS data to the tracer system 100 such that the customer 105 can track the item while in transit. The device 115 can compile fidelity data of the item during transit to the destination and relay the data to the tracer system 100. The fidelity data can include sound, movement, g-force, temperature, humidity brightness, and/or the like. For example, a large sudden g-force detected can be recorded and analyzed as indicative of the item being dropped or mishandled. In another example, a brightness level of the inside of the package changing can be recorded and analyzed as indicative of the item being opened or tampered.

At 520, delivery of the item to the destination is detected via the device 115 to activate theft monitoring. In some embodiments, delivery is detected by matching the location of the item with a destination location associated with the destination. Theft monitoring of the item by the device is triggered. The theft monitoring can be triggered upon confirming delivery at the destination. In some embodiments, the theft monitoring is triggered after a motion timeout at the destination to afford the delivery person or shipping mode time to settle the item at the destination. In other embodiments, the theft monitoring can be triggered upon the device 115 sensing, detecting, or connecting to a wireless network or wireless protocol associated with the customer 105.

At 525, a determination is made whether a theft is detected. The determination can be made by the device 115 or tracer system 100. The device 115 can detecting a theft of the item at the destination by detecting motion of the item via the device and/or tracer system. Detecting motion can include a change in location, an applied g-force, a brightness level change, a sound level change, a combination of factors, and/or the like.

If a theft is detected, at 530, theft deterrent measures are activated by the device 115. The theft deterrent measures can include sending a notification to the customer (e.g. intended recipient), sounding an alarm via the device, vibrating the device, notifying a police authority, broadcasting the location of the device and the item, and/or the like.

At 535, evidence collection can be activated by the device 115. The device 115 can collect evidence in tandem with the theft deterrent measures or separately. The evidence collection can include recording video and audio, collection of ambient measurements, collecting surrounding network information, biometric scan, phone scan, and/or the like. For example, if the item has been stolen and is being carried by the thief, the device 115 can scan for or connect to the thief's phone to obtain identifying information, such as a Bluetooth identifier, Bluetooth broadcast name, phone number, IMEI number, and/or the like.

At 540, a deactivation indication for customer pick up of the item 110 is received before a theft is detected, monitoring is deactivated. In some embodiments, the deactivation can be performed by a customer 105 expressly sending a deactivation request to the tracer system 100. In other embodiments, the device 115 can sense the customer near the item and deactivate theft monitoring. For example, the device 115 can determine a customer device (e.g. a customer phone) near the item and deactivate the theft monitoring.

At 545, upon determining a successful pickup of the item 110, instructions can be given to the customer 105 regarding returning the device 115. For example, upon deactivating the theft monitoring, the tracer system 100 can send return instructions to the customer's mobile device, email, other contact information, and/or the like. In some embodiments, the device 115 includes pre-addressed packaging for returning the device 115.

The following are specific non-limiting example use cases and embodiments of the innovation. It is appreciated that further use cases and embodiments are also contemplated. In some embodiments, a customer puts a high value item in their online cart on a customer device. Based on a high value product being put in the cart, a pop-up alert during the checkout process can ask the customer if they want a theft deterrent and/or tracking option to be added to the cart. In some embodiments, the pop-up alert will provide description of product and service. The pop-up alert can facilitate the customer add theft deterrent and/or tracking to the order. In some embodiments, the customer can order multiple devices for items in the same order. In other embodiments, upon adding the service to the order, information about the device, service, return process, and/or the like can be provided.

In some embodiments, the device can be stored in warehouse associated with the e-commerce site or agent of the e-commerce site, and/or the like. A warehouse employee can scan the device and scan a customer order associated with the customer's cart to associate the device and the order. In some embodiments, the device can be activated using a manual activation (e.g. a button), automatically activated upon scanning the device, remotely activated, and/or the like. The device and the item can be secured or packaged together.

Upon activation, the device can start to relay GPS coordinates on a time interval (e.g. every 15 or 30 minutes). In some embodiments, the relay can be on a schedule or the intervals change based on a schedule. For example, the interval for relay can be 15 minutes between 7:00 am and 7:00 pm, and 4 hours between 7:01 pm and 6:59 am. In some embodiments, the timing can be based on time zone of the destination, origin, present location, and/or the like. The GPS coordinates can be tracked while the item is in transit.

Upon delivery, a delivery driver can set the item at the destination. Delivery confirmation can be detected by the device or by a confirmation from the delivery driver. In some embodiments, the delivery driver scans a code on the item, device, or package to indicate the item has been delivered. In this embodiment, a system associated with the delivery (or shipping) service can send an API call to a tracer system associated with the theft deterrence and tracking service. The tracer system can send an activation notification to the device indicating delivery and device firmware can activate theft monitoring and theft deterrence services. In some embodiments, an accelerometer can zero itself or after have a timeout (e.g. 10 seconds) before the theft monitoring becomes active to prevent false alarms due to delivery driver setting package down at the same time as scanning it as delivered. The tracer system can send notification to the customer device and include a note that theft deterrent is active and engaged.

If the device (e.g. accelerometer) detects motion, the tracer system assumes there is an attempted theft of the item from the destination. In some embodiments, an audible alert is sounded to deter the theft in progress. The device can send a notification to the customer advising of motion detection and that the item is possibly being stolen. In some embodiments, the device can simultaneously send notification through a mobile application or website to the shipper of the item advising of possible theft in progress. The device will start to relay GPS locations on a predetermined interval (e.g. every 10 seconds) or on a continuous basis. In some embodiments, the GPS relay intervals variable based on available battery or data cost. In some embodiments, the alarm can continue to alert for until the end of a timeout period (e.g. 30 or 45 seconds). In some embodiments, after the timeout period, the alarm can alert a wind down sound to fool a persistent thief to believe the battery has died, however the device continues tracking via GPS location relays.

If no theft, the customer can disarm theft deterrence and return the device. The customer, an agent of the customer, other recipients, and/or the like can open an e-commerce application on a mobile device (or computing device). The customer can select the specific device they want to disarm. In some embodiments, the customer may have ordered multiple devices. The e-commerce application can display each device linked to associated orders. The customer can select the specific device they want to disarm, and select disarm, the e-commerce application can contact servers associated with the theft deterrent and tracking system to send a notification to device that will disarm the device. The device can receive the disarm notification and send a disarm confirmation back once disarmed. The tracer system can relay the disarm notification to the e-commerce application. In some embodiments, if the device is not able to be disarmed, the tracer system can detect a disarm request from the customer via the application to recognize that the customer tried to disarm the package to record a false positive of theft during pickup.

Upon disarming the device, the customer can separate the device from the item. For example, removing the device from a locked blister package. The customer can be provided and use a prepaid envelope that came with device to place the device in the envelope and put the envelope in a mailbox or the like to complete the return. In some embodiments, the device is returned to the e-commerce warehouse. The device is mailed to the e-commerce warehouse. When the device arrives at the e-commerce warehouse, the device can be charged. Upon charging, the device can recognize a voltage change from the device being charge. The device can cross reference the current location to confirm that the device is in the e-commerce warehouse. The device can send a message to the shipper and/or the customer to confirm the device has been successfully returned.

In some embodiments, after a completed shipment, the tracking data from during the shipment can be analyzed. The tracking data is analyzed for care of the shipment. The analysis can result in a delivery score (or shipping score) for the shipper/courier, the specific delivery person/driver, for offices of the shipper/courier, routes, shipping mode (e.g. air, land, seas, etc.), destination location, origin location, and/or the like. In some embodiments, he tracking data can also be stored as evidence during insurance claims on a damaged shipment to determine the responsible party for damaging the shipment.

In some embodiments, a shipping customer can request a device to send an item from their home or private business instead of operating with an e-commerce website. The shipping customer can access a website associated with the tracer system for theft deterrent and tracking service to be sent a device such that the shipping customer can include the device with the shipment. The shipping customer can add the device to a cart in a website and be shipped the device. The shipping customer can activate the device directly through the website. The website can provide instructions on how to identify a tracking number from the shipper. The shipping customer can log into the website and pair the device with the tracking number to activate the device. The shipping customer can ship device secured with the item to an intended recipient. Theft deterrence and tracking can proceed as described above.

In some embodiments, the device includes various hardware components. The device can include a cellular device for example a cellular device using cellular technology and/or cellular network (e.g. Category M1, 4G, 5G, other networks known and unknown, and/or the like). The device can include an accelerometer for motion detection. The device can include a speaker for alarming. The speaker can include a memory for recorded announcements to be played in conjunction with the alarm. For example, speaker generates an alarm, then announces “package theft, police notified” then a second alarm, announcement, and the like. The device can include one or more processors to apply instructions such a software application, firmware, and/or the like. In some embodiments, the device can update firmware on micro and module over the air (OTA) standards. The device can include a status light (e.g. a light emitting diode (LED)) to indicate status. The device can include audible status sounds via a speaker. The device can include a battery to provide power for tracking and theft deterrent hardware.

In some embodiments, the device communicates with a transit device located in the shipping mode. The transit device includes location tracking and communication technology to relay the location to the tracer system. The device communicates its presence within the shipping mode to the transit device. In some embodiments, the transit device scans a passive code on the device to confirm the device (and item) presence within the shipping mode. In some embodiments, the device connects to a destination IOT device to confirm location and/or delivery of the device and the item to the tracer system. The device can utilize passive or active architecture to provide a transit device to destination IOT device handoff recorded by the tracer system.

The innovation disclosed and claimed herein, in one aspect thereof, comprises systems and methods of theft deterrence and tracking of items. As described, the method comprises receiving an indication to track an item to a destination. The device is secured with the item, wherein the device is associated with the item. The device is trackable to determine a location of the item. The location of the device and the item is tracked to the destination.

A system, comprising a processor coupled to a memory that stores instructions that when executed cause the processor to: receive an indication to track an item to a destination; secure a device with the item, wherein the device component is associated with the item, and wherein the device component is trackable to determine a location of the item; and track the location of the device component and the item to the destination.

A computer readable medium having instructions to control one or more processors configured to receive an indication to track an item to a destination; secure a device with the item, wherein the device component is associated with the item, and wherein the device component is trackable to determine a location and fidelity of the item; and track the location and the fidelity of the device and the item to the destination.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

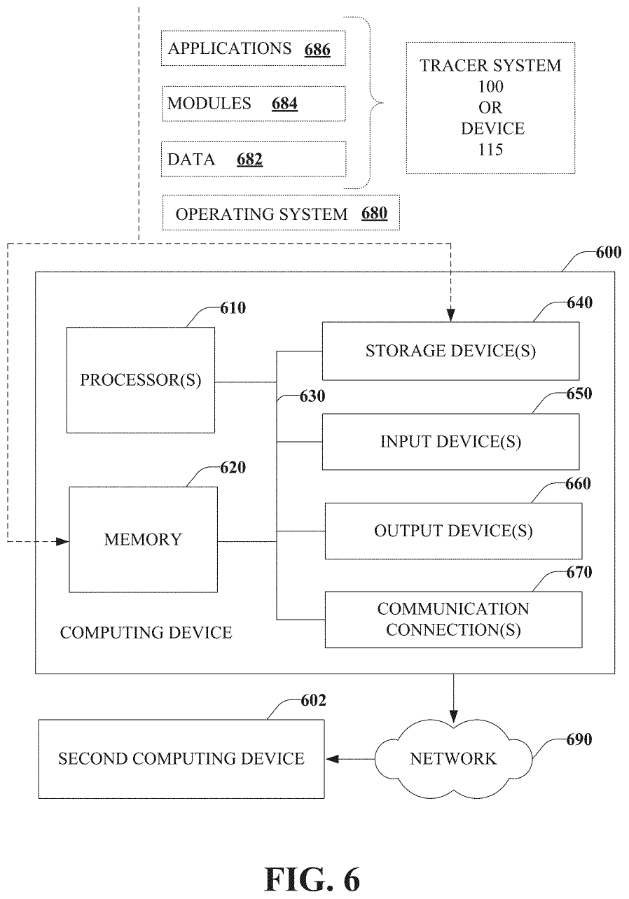

To provide a context for the disclosed subject matter, FIG. 6 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 6, illustrated is an example computing device 600 (e.g., desktop, laptop, tablet, watch, server, hand-held, programmable consumer or industrial electronics, set-top box, game system, compute node . . . ). The computing device 600 includes one or more processor(s) 610, memory 620, system bus 630, storage device(s) 640, input device(s) 650, output device(s) 660, and communications connection(s) 670. The system bus 630 communicatively couples at least the above system constituents. However, the computing device 600, in its simplest form, can include one or more processors 610 coupled to memory 620, wherein the one or more processors 610 execute various computer executable actions, instructions, and or components stored in the memory 620.

The processor(s) 610 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 610 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 610 can be a graphics processor unit (GPU) that performs calculations with respect to digital image processing and computer graphics.

The computing device 600 can include or otherwise interact with a variety of computer-readable media to facilitate control of the computing device to implement one or more aspects of the disclosed subject matter. The computer-readable media can be any available media that accessible to the computing device 600 and includes volatile and nonvolatile media, and removable and non-removable media. Computer-readable media can comprise two distinct and mutually exclusive types, namely storage media and communication media.

Storage media includes volatile and nonvolatile, removable, and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 600. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 620 and storage device(s) 640 are examples of computer-readable storage media. Depending on the configuration and type of computing device, the memory 620 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 600, such as during start-up, can be stored in nonvolatile memory, while volatile memory can act as external cache memory to facilitate processing by the processor(s) 610, among other things.

The storage device(s) 640 include removable/non-removable, volatile/non-volatile storage media for storage of vast amounts of data relative to the memory 620. For example, storage device(s) 640 include, but are not limited to, one or more devices such as a magnetic or optical disk drive, floppy disk drive, flash memory, solid-state drive, or memory stick.

Memory 620 and storage device(s) 640 can include, or have stored therein, operating system 680, one or more applications 686, one or more program modules 684, and data 682. The operating system 680 acts to control and allocate resources of the computing device 600. Applications 686 include one or both of system and application software and can exploit management of resources by the operating system 680 through program modules 684 and data 682 stored in the memory 620 and/or storage device(s) 640 to perform one or more actions. Accordingly, applications 686 can turn a general-purpose computer 600 into a specialized machine in accordance with the logic provided thereby.

All or portions of the disclosed subject matter can be implemented using standard programming and/or engineering techniques to produce software, firmware, hardware, or any combination thereof to control the computing device 600 to realize the disclosed functionality. By way of example and not limitation, all or portions of the tracer system 100 and device 115 can be, or form part of, the application 686, and include one or more modules 684 and data 682 stored in memory and/or storage device(s) 640 whose functionality can be realized when executed by one or more processor(s) 610.

In accordance with one particular embodiment, the processor(s) 610 can correspond to a system on a chip (SOC) or like architecture including, or in other words integrating, both hardware and software on a single integrated circuit substrate. Here, the processor(s) 610 can include one or more processors as well as memory at least similar to the processor(s) 610 and memory 620, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the tracer system 100 and device 115 and/or functionality associated therewith can be embedded within hardware in a SOC architecture.

The input device(s) 650 and output device(s) 660 can be communicatively coupled to the computing device 600. By way of example, the input device(s) 650 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 660, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 650 and output device(s) 660 can be connected to the computing device 600 by way of wired connection (e.g., bus), wireless connection (e.g., Wi-Fi, Bluetooth . . . ), or a combination thereof.

The computing device 600 can also include communication connection(s) 670 to enable communication with at least a second computing device 602 by means of a network 690. The communication connection(s) 670 can include wired or wireless communication mechanisms to support network communication. The network 690 can correspond to a local area network (LAN) or a wide area network (WAN) such as the Internet. The second computing device 602 can be another processor-based device with which the computing device 600 can interact. For example, the computing device 600 can correspond to a server that executes functionality of the tracer system 100 and device 115, and the second computing device 602 can be a user device that communications and interacts with the computing device 600.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
receiving an indication to track an item to a destination;
securing a device with the item, wherein the device is associated with the item, and wherein the device is trackable to determine a location of the item; and
tracking the location of the device component and the item to the destination.

2. The method of claim 1, comprising:
detecting delivery of the item to the destination via the device;
triggering theft monitoring of the item by the device upon detecting delivery of the item.

3. The method of claim 2, comprising:
wherein detecting delivery comprises:
scanning the item at the destination to mark the item as delivered at a shipping company portal; and
determining the item is delivered by a tracer system connecting to the shipping company portal to determine the item has been marked as delivered.

4. The method of claim 2, comprising:
detecting a theft of the item at the destination;
activating theft deterrent measures based on detecting the theft.

5. The method of claim 4, comprising:
wherein the theft deterrent measures includes at least one of sending a notification to an intended recipient of the item, sounding an alarm via the device, vibrating the device, notifying a police authority, broadcasting the location of the device and the item, recording video and audio, collection of ambient measurements, or collecting surrounding network information.

6. The method of claim 5, wherein detecting a theft of the item comprises:
detecting motion of the item via the device, wherein detecting motion includes at least one of a change in location, an applied g-force, a brightness level change, or a sound level change.

7. The method of claim 1, comprises:
wherein the device compiles fidelity data of the item during transit to the destination.

8. The method of claim 7, comprising:
wherein the fidelity data includes at least one of sound, movement, g-force, temperature, humidity, or brightness.

9. The method of claim 2, comprising:
confirming location of the item by communicating, via the device, with a transit device during transit; and
confirming location of the item by communicating, via the device, with a destination IOT device upon delivery of the item at the destination.

10. A system, comprising:
a processor coupled to a memory that includes instructions that when executed by the processor cause the processor to:
receive an indication to track an item to a destination;
secure a device with the item, wherein the device component is associated with the item, and wherein the device component is trackable to determine a location of the item; and
track the location of the device component and the item to the destination.

11. The system of claim 10, comprising:
detect delivery of the item to the destination via the device;
trigger theft monitoring of the item by the device upon detecting delivery of the item.

12. The system of claim 11, comprising:
wherein detecting delivery comprises determining the location of the item matches a destination location associated with the destination; and
wherein triggering theft monitoring comprises detecting an absence of change in location or an absence of movement for a predetermined timeout.

13. The system of claim 11, comprising:
detect a theft of the item at the destination;
activate theft deterrent measures based on detecting the theft.

14. The system of claim 14, comprising:
wherein the theft deterrent measures includes at least one of sending a notification to an intended recipient of the item, sounding an alarm via the device, vibrating the device, notifying a police authority, broadcasting the location of the device and the item, recording video and audio, collecting ambient measurements, or collecting surrounding network information.

15. The system of claim 14, wherein detecting a theft of the item comprises:
detect motion of the item via the device, wherein detecting motion includes at least one of a change in location, an applied g-force, a brightness level change, or a sound level change.

16. The system of claim 10, comprises:
wherein the device compiles fidelity data of the item during transit to the destination, wherein the fidelity data includes at least one of sound, movement, g-force, temperature, or brightness.

17. The system of claim 10, comprising:
wherein the device is cellular device to provide tracking information over a cellular network.

18. The system of claim 11, comprising:
confirm location of the item by communicating, via the device, with a transit device during transit; and
confirm location of the item by communicating, via the device, with a destination IOT device upon delivery of the item at the destination.

19. A computer readable medium having instructions to control one or more processors configured to:
receive an indication to track an item to a destination;
secure a device with the item, wherein the device component is associated with the item, and wherein the device component is trackable to determine a location and fidelity of the item; and
track the location and the fidelity of the device and the item to the destination.

20. The computer readable medium of claim 19, wherein the one or more processors are further configured to:
detect delivery of the item to the destination via the device; and
trigger theft monitoring of the item by the device upon detecting delivery of the item.
